(19) United States
(12) Patent Application Publication
(10) Pub. No.: US 2005/0091131 A1
(43) Pub. Date: Apr. 28, 2005

(54) Method of consignment selling

(76) Inventor: Brian K. Ginis, Parma Heights, OH (US)

Correspondence Address: Joseph T. Leone;DeWitt Ross & Stevens S.C., 8000 Excelsior Drive, Madison, WI, 53717, US

(21) Appl. No.: 10/981,117

(22) Filed: Nov. 4, 2004

Related U.S. Application Data
(63) Continuation-in-part of application No. 09/551,458, filed on Apr. 18, 2000.

(51) Int. Cl. G06F 17/60

(52) U.S. Cl. 705/30; 705/28

(57) ABSTRACT

Disclosed is a method of selling wherein a good or service is offered for sale at an initial asking price, X. The asking price, X, is then reduced by a desired amount per a fixed time period until the good or service is sold or its asking price is reduced to zero.

### CROSS-REFERENCE TO RELATED APPLICATIONS

This is a continuation-in-part of co-pending application Ser. No. 09/551,458, filed Apr. 18, 2000, the entire contents of which is incorporated herein by reference.

### FIELD OF THE INVENTION

The invention relates to methods of consignment selling wherein an item for sale is offered at an initial point in time, at a starting asking price. At regular time intervals subsequent to the initial point in time, the asking price is reduced a fixed amount (either in absolute terms or percentage-wise). The process is repeated until the item is sold or the asking price is reduced to zero, at which point the item is returned to the consignor or discarded as unsaleable.

### DESCRIPTION OF THE PRIOR ART

Human kind has been engaged in the art of “selling” and “buying” for millennia. Up until the time of the industrial revolution in western Europe and the United States, the global economy was almost entirely agricultural in nature. Goods were bought and sold by barter, rather than by the exchange of asset-backed notes or fiat currency.

However, as the world economy became dominated more and more by manufactured goods, banking systems arose to provide the economic liquidity and convenience which could not be afforded by the barter system. Money, first backed by gold or silver, and now free-floating fiat currency backed by the faith of national governments, came to become the world-wide medium by which the value of goods and services are now judged.

Many systems have been developed to maximize the asking price of goods (for the benefit of sellers) or to minimize the bidding cost (for the benefit of buyers). The simple auction is likely the oldest such system. In a conventional auction, the item for sale is simply sold to the buyer offering the most attractive price. The stock markets, futures markets, commodities markets, etc. are nothing more than an interlocking world-wide system which operates according to a straightforward “auction” system: Buyers post bids of the price they are willing to pay for a certain security, sellers post asking prices. Brokers match buyers and sellers (for a fee), thereby providing liquidity to the securities markets.

Consignment selling is another form of auctioneering. Here, the seller (the consignor) places the item to be sold with a consignee. The consignee then attempts to find buyers interested in the item and to maximize the return to the consignor upon sale of the item. Because the consignee's fee is often based upon a percentage of the selling price, maximizing the selling price of the item increases the return both to the consignor and the consignee. However, if the item cannot be sold at the minimum asking price specified by the consignor or set by the consignee, the only option is to return the item to the consignor.

### DETAILED DESCRIPTION OF THE INVENTION

The invention is a method of selling (either by consignment or otherwise) wherein an item for sale is offered at an initial point in time, at a starting asking price. At regular time intervals subsequent to the initial point in time, the asking price is reduced a fixed amount (either in absolute terms or percentage-wise). The process is repeated at regular intervals until the item is sold or the asking price is reduced to zero, at which point the item is either returned to the consignor or discarded as unsaleable.

There are several advantages to the present method of selling which become apparent when the method is implemented at either the retail or wholesale level: First, it stimulates store traffic by creating a need in potential buyers to revisit the store to see if the item for sale has yet been purchased. For example, if item X (which is of interest to the potential buyer) initially goes on sale on a Monday, according to the method, the item's initial asking price might be decreased by 1% per day, until sold. Therefore, a buyer might visit the store again on Tuesday, when the price would be X−1%, on Wednesday (price=X−2%), on Thursday (X−3%), etc. By Friday or by some day in the following week, the potential buyer likely begins to worry whether another interested buyer will purchase the item as its price continues to drop. At some point, the price becomes irresistible, and the item is purchased at a price which equals X minus a certain percentage. Even if the potential buyer doesn't buy until the 20^{th} or even 50^{th} day, he or she has likely visited the store numerous times since the initial offering date of the item, thereby increasing customer volume in the store and thereby increasing the likelihood of additional, ancillary sales to the customer.

If there are two or more potential customers interested in the same item, the first to purchase will likely leave the other, unsuccessful buyers disappointed and more likely to purchase at an earlier point in the price reduction schedule when the next item of interest comes up for sale. This effect encourages potential buyers not to wait too long for very desirable items; otherwise, the items will be purchased by competing buyers.

Another advantage of the method is that it provides a self-limiting means to control burgeoning inventory, especially for the consignment seller. Taking the above example, assume that an item is offered at an initial asking price X. This price is then reduced 1% per day, until the item is sold. At the end of the 100 day, the item's sale price becomes zero (0). If the item has not sold by the end of the reduction schedule, at which point its asking price is zero, the item is either returned to the consignor or discarded as unsaleable. In this manner, the market sets the price for the value of goods, thereby eliminating the consignment seller's need to determine what should be maintained in inventory and what should remain on the shelves.

In practice, the method works as follows: an item is brought by a seller (designated herein as the “consignor”) to a consignee for sale. The consignor and consignee, if desired, can agree on an initial asking price, or the initial asking price can be set solely by the consignee (based upon his or her knowledge of the relevant market). A regular reduction schedule is then established for the item and posted so that the buying public is aware of the reduction schedule. For example, the initial asking price for an item might be set at $100, and the reduction schedule calls for a $1 reduction in price, per day, until the item is sold. A critical aspect of the subject method is that the reduction schedule must be communicated to the potential buyers. By communicating this information to potential buyers, the reduction schedule creates a sustained excitement in the buyers. In short, by judiciously waiting for the reduction schedule to lower the price of the desired item, and by keeping a close eye on their quarry, buyers might get an opportunity to purchase a desired item at a greatly reduced price.

The reduction schedule is preferably constant (either in absolute terms or in percentage terms) although it need not be. For example, the reduction schedule could call for a $1 per day price reduction or a 1% per day price reduction, as exemplified above. Or, the reduction schedule could call for accelerated price reductions if the item remains unsold. For example, starting on day 1 of week 1, the asking price could be reduced 1% per day for each day of week 1, 2% per day for each day of week 2, etc. For an item initially priced at $100 and assuming 5 days per week, such an item would remain on sale for 6 weeks until its value was reduced to zero. (1% per day in week 1=$5, 2% per day in week 2=$10, 3% per day in week 3=$15, 4% per day in week 4=$20, 5% per day in week 5=$25, 6% per day in week 6=$30). By day 1 of week 6, the initial asking price would be reduced to $25 By day 5 of week 6, the asking price would be $1.

Similarly, the reduction schedule could operate on a fixed or accelerating reduction based on a fixed sum per time period. For example, the reduction schedule could call for a reduction in the initial asking price of $1 per day until sold. Or, in the same fashion as noted above, $1 per day during week 1, $2 per day during week 2, etc.

Using the above examples solely as guidelines, any number of reduction schedules, either regular, accelerating, decelerating, or any combination thereof, can be easily envisioned.

The only critical element of the reduction schedule is that it must be accurately communicated to the potential buyers so that each buyer may evaluate for himself or herself whether the time is ripe to make a purchase or whether there is continued room for downward movement in the price before the item is snapped up by a competing buyer.

In practice, the reduction schedule is implemented using a programmable computer. The term “programmable computer” as used herein includes programmable computers of any description, including, without limitation, a conventional electronic cash register, or a laptop computer, desktop computer, or mainframe computer that has been programmed to record the starting sale date of each item and the starting price of each item, and that can correlate the starting date and price information with the pre-determined reduction schedule. The programmable computer then computes the appropriate price for any given item at any given point in time. The programmable computer also alerts the proprietor when the value of a consigned item has been reduced to zero. In this fashion, the offering price of any given item can then be determined quickly and easily by consulting the computer. Thus, in practice, once the reduction schedule has been established, the reduction schedule is entered into a programmable computer. The programmable computer is then used to reduce the price, X, according to the established reduction schedule. This is reiterated until the good or service is sold or its asking price is reduced to zero.

The inventive selling method described and claimed herein is not limited to the above-described embodiments, but encompasses all equivalent embodiments which are within the scope of the attached claims.

1. A method of consignment selling of goods or services comprising the steps of:
(a) offering from a consignor's inventory the good or service for sale on consignment at an initial asking price, X, at an initial point in time;
(b) establishing a reduction schedule wherein X is reduced by a desired amount per a fixed time period subsequent to the initial point in time;
(c) entering the reduction schedule into a programmable computer;
(d) communicating the reduction schedule to potential buyers of the good or service; and then
(e) using the programmable computer of step (c), reducing X according to the established reduction schedule of step (b) until the good or service is sold or its asking price is reduced to zero; and then
(f) eliminating the good or service from the consignor's inventory if X is reduced to zero.

2. The method of claim 1, wherein in step (b), a reduction schedule is established wherein X is reduced by a percentage per fixed time period.

3. The method of claim 2, wherein the fixed time period is per week.

4. The method of claim 2, wherein the fixed time period is per day.

5. The method of claim 1, wherein in step (b), a reduction schedule is established wherein X is reduced by an absolute sum per fixed time period.

6. The method of claim 5, wherein the fixed time period is per week.

7. The method of claim 5, wherein the fixed time period is per day.

8. The method of claim 1, wherein in step (b), a reduction schedule is established wherein X is reduced by a fixed percentage per fixed time period.

9. The method of claim 8, wherein the fixed time period is per week.

10. The method of claim 8, wherein the fixed time period is per day.

11. The method of claim 1, wherein in step (b), a reduction schedule is established wherein X is reduced by a fixed absolute sum per fixed time period.

12. The method of claim 11, wherein the fixed time period is per week.

13. The method of claim 11, wherein the fixed time period is per day.

14. The method of claim 1, wherein in step (b), a reduction schedule is established wherein X is reduced by a varying percentage per fixed time period.

15. The method of claim 1, wherein in step (b), a reduction schedule is established wherein X is reduced by a varying absolute sum per fixed time period.

16. A method of consignment selling of goods or services comprising the steps of:
(a) offering from a consignor's inventory the good or service for sale on consignment at an initial asking price, X, at an initial point in time;
(b) establishing a reduction schedule wherein X is reduced by 1% per day subsequent to the initial point in time;
(c) entering the reduction schedule into a programmable computer;
(d) communicating the reduction schedule to potential buyers of the good or service; and
(e) using the programmable computer of step (c), reducing X according to the established reduction schedule of step (b) until the good or service is sold or its asking price is reduced to zero; and then
(f) eliminating the good or service from the consignor's inventory if X is reduced to zero.

17. A method of consignment selling of goods or services comprising the steps of:
(a) offering from a consignor's inventory the good or service for sale on consignment at an initial asking price X, at an initial point in time;
(b) establishing a reduction schedule wherein X is reduced by a fixed sum per day subsequent to the initial point in time;
(c) entering the reduction schedule into a programmable computer;
(d) communicating the reduction schedule to potential buyers of the good or service; and then
(e) using the programmable computer of step (c), reducing X according to the established reduction schedule of step (b) until the good or service is sold or its asking price is reduced to zero; and then
(f) eliminating the good or service from the consignor's inventory if X is reduced to zero.
